(19) United States
(12) Patent Application Publication
(10) Pub. No.: US 2016/0042479 A1
(43) Pub. Date: Feb. 11, 2016

(54) AUTOMATIC CHECK-IN AND FACILITATION OF PROPERTY RELATED SERVCIES

(71) Applicants: Daniel Oertli, Sydney (AU); Pete Williams, Prahran (AU)

(72) Inventors: Daniel Oertli, Sydney (AU); Pete Williams, Prahran (AU)

(21) Appl. No.: 14/819,420

(22) Filed: Aug. 5, 2015

Related U.S. Application Data
(60) Provisional application No. 62/033,614, filed on Aug. 5, 2014.

(51) Int. Cl. G06Q 50/16; H04L 29/08; G06F 17/30

(52) U.S. Cl. CPC G06Q 50/16; G06F 17/30368; H04L 67/306

(57) ABSTRACT

A method of automatic check-in and facilitation of property related services is disclosed. A realty interaction server creates a property profile in a database, including a list of high interest prospects and a list of visitors. The server also creates a prospect profile, and automatically populates the prospect profile by querying a third party server using a prospect's phone number or email address. The server facilitates an open house check-in by processing an agent UUID and communicating at least a portion of the prospect profile to the agent and at least a portion of the property profile to the prospect. The list of high interest prospects associated with the property profile is updated using a predictive engine.

### CLAIM OF PRIORITY

This application is a non-provisional conversion application of and claims priority to the U.S. Provisional application No. 62/033,614 titled AUTOMATIC CHECK-IN AND FACILITATION OF PROPERTY RELATED SERVICES filed on Aug. 5, 2014.

### FIELD OF TECHNOLOGY

This disclosure relates generally to real property and, more particularly, to a system, a method, and/or apparatus for automatic check-in and facilitation of property related services.

### BACKGROUND

The process of purchasing or renting a home can be overwhelming. There may be a large amount of information a prospective buyer must keep track of when comparing different properties. During an open house, it may be difficult to get the information desired. Additionally, when visiting a property at a time when the agent is not present or an open house is not in progress, the information available to the prospect is limited.

Furthermore, the process of selling or renting a home may be difficult, as it may be difficult to quickly identify likely purchasers or renters. An agent may have to sift through a large number of potential buyers, with limited information about each, in trying to decide where to focus their efforts. Some prospects have property related needs they are not able to readily articulate, but have tended to gravitate toward during their search. The difficulty in conveying this information may make the purchasing or renting process frustrating and inefficient for both the prospect and agent.

### SUMMARY

Disclosed are a system, a method, and/or apparatus for automatic check-in and facilitation of property related services. In one aspect, a method of a realty interaction server includes creating a property profile of a property in a database, using a processor and a memory. The property profile includes a list of high interest prospects, a list of visitors, a property identifier, an address, and a photo. The method further includes associating the property profile with an agent, and creating a prospect profile of a prospect in the database. Additionally, the method includes automatically populating the prospect profile by querying a third party server through a network using the prospect's phone number and the prospect's email address.

The method of a realty interaction server also includes determining that the agent is holding an open house at the property and that an agent client is broadcasting an agent UUID, as well as processing the agent UUID detected by a prospect client. Additionally, the method includes notifying the agent client and the prospect client that the prospect has successfully checked in to the open house, communicating at least a portion of the prospect profile to the agent client, and communicating at least a portion of the property profile to the prospect client.

The method also includes updating the list of high interest prospects associated with the property profile using a predictive engine, communicating the list of high interest prospects to the agent client, and recording when the prospect has left the open house in the database. The prospect is at least one of a potential buyer and a potential renter. Also, the prospect client is a realty interaction client associated with the prospect, and the agent client is a realty interaction client associated with the agent.

The processing of the agent UUID detected by the prospect client may be performed in response to the agent UUID being communicated to the realty interaction server automatically by the prospect client. The prospect profile may include a name, an employer, the phone number, the email address, an educational institution, a potential reference, a lending institution, a loan pre-approval, an age, a photo, a list of properties visited, a list of property profiles viewed, and/or a list of open houses attended.

The predictive engine may populate the list of high interest prospects by quantifying an interest level of a prospect based upon a number of times the prospect has visited the property, an amount of time spent at the property in an open house, a number of other properties visited, a location of other properties visited, a number of property profiles viewed, a ratio of properties viewed through the prospect client to the number of properties visited, and/or whether the property is being followed by the prospect.

The method of a realty interaction server may further include associating a beacon UUID of a beacon with the property profile and processing a beacon UUID detected by the prospect client and a current beacon location. The current beacon location may be a set of geo-spatial coordinates captured through the prospect client when the beacon UUID is detected. The method may also include validating the current beacon location by comparing the current beacon location with the property profile, as well as notifying the agent associated with the property profile when the current beacon location is inconsistent with the property profile. Also, the method may further include updating the prospect profile and/or the property profile with a property visit when the current beacon location is consistent with the property profile, as well as communicating at least a portion of the property profile to the prospect client. The predictive engine may populate the list of high interest prospects based further upon a number of times the prospect has visited the property while the agent was not present.

The method of a realty interaction server may also include providing a CRM system with information comprising a portion of the property profile, and/or a portion of the prospect profiles of prospects who have visited the property. The CRM system may be a database associated with the agent. Also, the method may include processing a request from the prospect client, communicating a portion of the request to a property service provider server, and reporting a response to the request to the prospect client.

The request may include a rental application, a loan approval application, a home inspection request, a home appraisal request, and/or a utility installation request. The response may include an appointment confirmation, a home inspection report, a home appraisal report, and/or a loan approval. Additionally, the prospect may opt out of sharing a portion of the prospect profile with the agent. The third party server may be a social network.

In another aspect, a method of a realty interaction server includes creating a property profile of a property in a database, using a processor and a memory. The property profile includes a list of high interest prospects, a list of visitors, a property identifier, an address, and a photo. The method also includes associating the property profile with an agent, creating a prospect profile of a prospect in the database, as well as automatically populating the prospect profile by querying a third party server through a network using the prospect's phone number and the prospect's email address.

Furthermore, the method of a realty interaction server includes associating a beacon UUID of a beacon with the property profile, and processing a beacon UUID detected by a prospect client and a current beacon location. The current beacon location is a set of geo-spatial coordinates captured through the prospect client when the beacon UUID is detected. Also included is validating the current beacon location by comparing the current beacon location with the property profile, and notifying the agent associated with the property profile when the current beacon location is inconsistent with the property profile.

The method may further include updating the prospect profile and the property profile with a property visit when the current beacon location is consistent with the property profile, and communicating a portion of the property profile to the prospect client. The prospect is a potential buyer or a potential renter. The prospect client is a realty interaction client associated with the prospect. The method may further include determining that the agent is holding an open house at the property and that an agent client is broadcasting an agent UUID, as well as processing the agent UUID detected by the prospect client.

The method of a realty interaction server may also include notifying the agent client and/or the prospect client that the prospect has successfully checked in to the open house, communicating a portion of the prospect profile to the agent client, communicating a portion of the property profile to the prospect client, and updating the list of high interest prospects associated with the property profile using a predictive engine. Finally, the method may include communicating the list of high interest prospects to the agent client, and recording when the prospect has left the open house in the database. The agent client may be a realty interaction client associated with the agent.

In yet another aspect, a system includes a network, a prospect client, a beacon, and an agent client. The system also includes a realty interaction server, including a database and a predictive engine. The realty interaction server creates a property profile of a property in the database, using a processor and a memory. The property profile includes a list of high interest prospects, a list of visitors, a property identifier, an address, and a photo. The realty interaction server associates the property profile with an agent, creates a prospect profile of a prospect in the database, and automatically populates the prospect profile by querying a third party server through the network using the prospect's phone number and the prospect's email address.

The system also includes the realty interaction server to determine that the agent is holding an open house at the property and that the agent client is broadcasting an agent UUID, to process the agent UUID detected by the prospect client, and to notify the agent client and the prospect client that the prospect has successfully checked in to the open house. The realty interaction server communicates a portion of the prospect profile to the agent client, and communicates a portion of the property profile to the prospect client.

Additionally, the system includes the realty interaction server to update the list of high interest prospects associated with the property profile using the predictive engine, to communicate the list of high interest prospects to the agent client, to record when the prospect has left the open house in the database, and to associate a beacon UUID of the beacon with the property profile. The realty interaction server processes a beacon UUID detected by the prospect client and a current beacon location. The current beacon location is a set of geo-spatial coordinates captured through the prospect client when the beacon UUID is detected. The realty interaction server also validates the current beacon location by comparing the current beacon location with the property profile, notifies the agent associated with the property profile when the current beacon location is inconsistent with the property profile, and updates the prospect profile and the property profile with a property visit when the current beacon location is consistent with the property profile.

Furthermore, the system includes the realty interaction server to communicate at least a portion of the property profile to the prospect client. The prospect is at a potential buyer or a potential renter, and the prospect client is a realty interaction client associated with the prospect. The agent client is a realty interaction client associated with the agent. Finally, the predictive engine populates the list of high interest prospects based further upon a number of times the prospect has visited the property while the agent was not present.

The methods and devices disclosed herein may be implemented in any means for achieving the various aspects. Other features will be apparent from the accompanying drawings and from the detailed description that follows.

### BRIEF DESCRIPTION OF THE DRAWINGS

Example embodiments are illustrated by way of example and not limitation in the Figures of the accompanying drawings, in which like references indicate similar elements and in which:

FIG. 1 shows a network view of a realty interaction server having a database communicating with a prospect client and an agent client, according to one embodiment.

FIG. 2 shows a database record view of a property profile of the database of FIG. 1, according to one embodiment.

FIG. 3 shows a database record view of a prospect profile of the database of FIG. 1, according to one embodiment.

FIG. 4 is a critical path view of an open house check-in interaction between the prospect client, the agent client, and the realty interaction server of FIG. 1, according to one embodiment.

FIG. 5 is a critical path view of an automatic visit registration interaction between a beacon, the prospect client of FIG. 1, and the realty interaction server of FIG. 1, according to one embodiment.

FIG. 6 is a process flow to notify the agent client of FIG. 1 that a prospect has checked in at an open house, according to one embodiment.

FIG. 7A is a user interface view of a property search performed through a realty interaction client, according to one embodiment.

FIG. 7B is a user interface view of a property summary associated with a search result of FIG. 7A as displayed through a realty interaction client, according to one embodiment.

FIG. 8 is an abstraction view of an agency hierarchy which may reflected in assigned UUIDs, according to one embodiment.

FIG. 9 is a schematic diagram of exemplary data processing devices that can be used to implement the methods and systems disclosed herein, according to one embodiment.

Other features of the present embodiments will be apparent from the accompanying drawings and from the detailed description that follows.

### DETAILED DESCRIPTION

Example embodiments, as described below, may be used to provide a system, a method, and/or apparatus for automatic check-in and facilitation of property related services. In the following description, for the purposes of explanation, numerous specific details are set forth in order to provide a thorough understanding of the various embodiments. It will be evident, however, to one skilled in the art that the various embodiments may be practiced without these specific details.

In one embodiment, a method of a realty interaction server 100 includes creating a property profile 126 of a property 118 in a database 122, using a processor 132 and a memory 134. The property profile 126 includes a list of high interest prospects 214, a list of visitors 216, a property identifier 200, an address 202, and a photo 204. The method further includes associating the property profile 126 with an agent, and creating a prospect profile 128 of a prospect 114 in the database 122. Additionally, the method includes automatically populating the prospect profile 128 by querying a third party server 108 through a network 106 using the prospect's phone number 302 and the prospect's email address 304.

The method of a realty interaction server 100 also includes determining that the agent 116 is holding an open house at the property 118 and that an agent client 104 is broadcasting an agent UUID 220, as well as processing the agent UUID 220 detected by a prospect client 102. Additionally, the method includes notifying the agent client 104 and the prospect client 102 that the prospect 114 has successfully checked in to the open house, communicating at least a portion of the prospect profile 128 to the agent client 104, and communicating at least a portion of the property profile 126 to the prospect client 102.

The method also includes updating the list of high interest prospects 214 associated with the property profile 126 using a predictive engine 124, communicating the list of high interest prospects 214 to the agent client 104, and recording when the prospect 114 has left the open house in the database 122. The prospect 114 is at least one of a potential buyer and a potential renter. Also, the prospect client 102 is a realty interaction client associated with the prospect 114, and the agent client 104 is a realty interaction client associated with the agent.

The processing of the agent UUID 220 detected by the prospect client 102 may be performed in response to the agent UUID 220 being communicated to the realty interaction server 100 automatically by the prospect client 102. The prospect profile 128 may include a name 300, an employer 306, the phone number 302, the email address 304, an educational institution 310, a potential reference 312, a lending institution 314, a loan pre-approval 316, an age, a photo 204, a list of properties visited 318, a list of property profiles 126 viewed, and/or a list of open houses attended 320.

The predictive engine 124 may populate the list of high interest prospects 214 by quantifying an interest level of a prospect 114 based upon a number of times the prospect 114 has visited the property 118, an amount of time spent at the property 118 in an open house, a number of other properties visited, a location of other properties visited, a number of property profiles 126 viewed, a ratio of properties viewed through the prospect client 102 to the number of properties visited, and/or whether the property 118 is being followed by the prospect 114.

The method of a realty interaction server 100 may further include associating a beacon UUID of a beacon with the property profile 126 and processing a beacon UUID detected by the prospect client 102 and a current beacon location. The current beacon location may be a set of geo-spatial coordinates 130 captured through the prospect client 102 when the beacon UUID is detected. The method may also include validating the current beacon location by comparing the current beacon location with the property profile 126, as well as notifying the agent 116 associated with the property profile 126 when the current beacon location is inconsistent with the property profile 126. Also, the method may further include updating the prospect profile 128 and/or the property profile 126 with a property 118 visit when the current beacon location is consistent with the property profile 126, as well as communicating at least a portion of the property profile 126 to the prospect client 102. The predictive engine 124 may populate the list of high interest prospects 214 based further upon a number of times the prospect 114 has visited the property 118 while the agent 116 was not present.

The method of a realty interaction server 100 may also include providing a CRM system 110 with information comprising a portion of the property profile 126, and/or a portion of the prospect profiles 128 of prospect 114s who have visited the property 118. The CRM system 110 may be a database 122 associated with the agent. Also, the method may include processing a request from the prospect client 102, communicating a portion of the request to a property service provider server 112, and reporting a response to the request to the prospect client 102.

The request may include a rental application, a loan approval application, a home inspection request, a home appraisal request, and/or a utility installation request. The response may include an appointment confirmation, a home inspection report, a home appraisal report, and/or a loan approval. Additionally, the prospect 114 may opt out of sharing a portion of the prospect profile 128 with the agent. The third party server 108 may be a social network.

In another embodiment, a method of a realty interaction server 100 includes creating a property profile 126 of a property 118 in a database 122, using a processor 132 and a memory 134. The property profile 126 includes a list of high interest prospects 214, a list of visitors 216, a property identifier 200, an address, and a photo. The method also includes associating the property profile 126 with an agent, creating a prospect profile 128 of a prospect 114 in the database 122, as well as automatically populating the prospect profile 128 by querying a third party server 108 through a network 106 using the prospect's phone number 302 and the prospect's email address 304.

Furthermore, the method of a realty interaction server 100 includes associating a beacon UUID of a beacon with the property profile 126, and processing a beacon UUID detected by a prospect client 102 and a current beacon location. The current beacon location is a set of geo-spatial coordinates 130 captured through the prospect client 102 when the beacon UUID is detected. Also included is validating the current beacon location by comparing the current beacon location with the property profile 126, and notifying the agent 116 associated with the property profile 126 when the current beacon location is inconsistent with the property profile 126.

The method may further include updating the prospect profile 128 and the property profile 126 with a property 118 visit when the current beacon location is consistent with the property profile 126, and communicating a portion of the property profile 126 to the prospect client 102. The prospect 114 is a potential buyer or a potential renter. The prospect client 102 is a realty interaction client associated with the prospect 114. The method may further include determining that the agent 116 is holding an open house at the property 118 and that an agent client 104 is broadcasting an agent UUID 220, as well as processing the agent UUID 220 detected by the prospect client 102.

The method of a realty interaction server 100 may also include notifying the agent client 104 and/or the prospect client 102 that the prospect 114 has successfully checked in to the open house, communicating a portion of the prospect profile 128 to the agent client 104, communicating a portion of the property profile 126 to the prospect client 102, and updating the list of high interest prospects 214 associated with the property profile 126 using a predictive engine 124. Finally, the method may include communicating the list of high interest prospects 214 to the agent client 104, and recording when the prospect 114 has left the open house in the database 122. The agent client 104 may be a realty interaction client associated with the agent.

In yet another embodiment, a system includes a network 106, a prospect client 102, a beacon, and an agent client 104. The system also includes a realty interaction server 100, including a database 122 and a predictive engine 124. The realty interaction server 100 creates a property profile 126 of a property 118 in the database 122, using a processor 132 and a memory 134. The property profile 126 includes a list of high interest prospects 214, a list of visitors 216, a property identifier 200, an address, and a photo. The realty interaction server 100 associates the property profile 126 with an agent, creates a prospect profile 128 of a prospect 114 in the database 122, and automatically populates the prospect profile 128 by querying a third party server 108 through the network 106 using the prospect's phone number 302 and the prospect's email address 304.

The system also includes the realty interaction server 100 to determine that the agent 116 is holding an open house at the property 118 and that the agent client 104 is broadcasting an agent UUID 220, to process the agent UUID 220 detected by the prospect client 102, and to notify the agent client 104 and the prospect client 102 that the prospect 114 has successfully checked in to the open house. The realty interaction server 100 communicates a portion of the prospect profile 128 to the agent client 104, and communicates a portion of the property profile 126 to the prospect client 102.

Additionally, the system includes the realty interaction server 100 to update the list of high interest prospects 214 associated with the property profile 126 using the predictive engine 124, to communicate the list of high interest prospects 214 to the agent client 104, to record when the prospect 114 has left the open house in the database 122, and to associate a beacon UUID of the beacon with the property profile 126. The realty interaction server 100 processes a beacon UUID detected by the prospect client 102 and a current beacon location. The current beacon location is a set of geo-spatial coordinates 130 captured through the prospect client 102 when the beacon UUID is detected. The realty interaction server 100 also validates the current beacon location by comparing the current beacon location with the property profile 126, notifies the agent 116 associated with the property profile 126 when the current beacon location is inconsistent with the property profile 126, and updates the prospect profile 128 and the property profile 126 with a property 118 visit when the current beacon location is consistent with the property profile 126.

Furthermore, the system includes the realty interaction server 100 to communicate at least a portion of the property profile 126 to the prospect client 102. The prospect 114 is at a potential buyer or a potential renter, and the prospect client 102 is a realty interaction client associated with the prospect 114. The agent client 104 is a realty interaction client associated with the agent. Finally, the predictive engine 124 populates the list of high interest prospects 214 based further upon a number of times the prospect 114 has visited the property 118 while the agent 116 was not present.

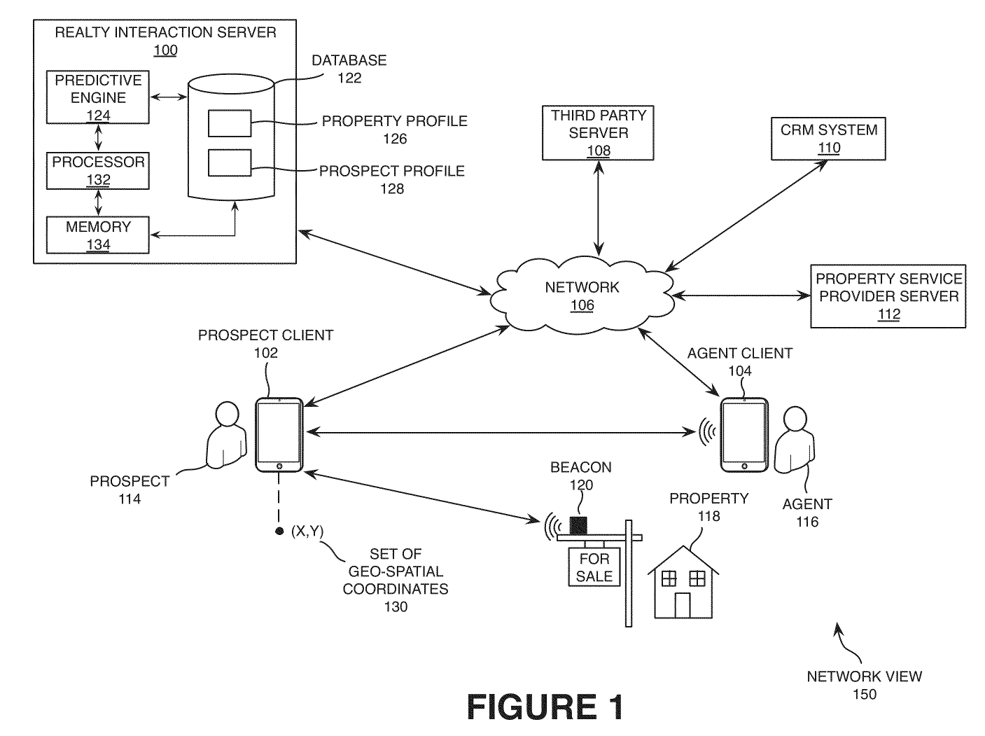

FIG. 1 shows a network view 150 of a realty interaction server 100 having a database 122 communicating with a prospect client 102 and an agent client 104, according to one embodiment. Particularly, FIG. 1 shows the realty interaction server 100, the prospect client 102, the agent client 104, a network 106, a third party servers 108, a CRM system 110, a property service provider server 112, a prospect, an agent 116, a property, a beacon 120, a database 122, a predictive engine 124, a property profile 126, a prospect profile 128, a set of geo-spatial coordinates 130, a processor 132, and a memory 134.

The realty interaction server 100 may be a computing system (e.g., a laptop, a desktop, a mobile device, etc.) and/or computer program that manages access to a centralized resource or service in a network 106. The database 122 may be a structured set of data held in a computer storage. The prospect client 102 may be a realty interaction client associated with a prospect. The realty interaction client may be an application running on a mobile device (e.g. a phone, a tablet, a laptop, a netbook, etc.) which may communicate with the realty interaction server 100 through a network 106. The agent client 104 may be a realty interaction client associated with an agent 116.

The network 106 may be a telecommunications network 106 (e.g. the internet, etc.) which allows computers to exchange data. The third party server 108 may be a computing system (e.g., a laptop, a desktop, a mobile device, etc.) and/or computer program that manages access to a centralized resource which may be controlled and/or owned by a third party. The CRM system 110 may be a customer management system, which may be software and/or hardware which enables a company to organize, manage, and/or optimize their interactions with customers/clients and potential customers/clients. The property service provider server 112 may be a server associated with a company or individual who provides services related to the purchase, sale, renting, and/or ownership of real property. The prospect 114 may be an individual who is a potential buyer and/or renter of real property, or an individual serving as a proxy for such an individual (e.g. a friend, a family member, etc.), or an individual interested in purchasing and/or renting real property.

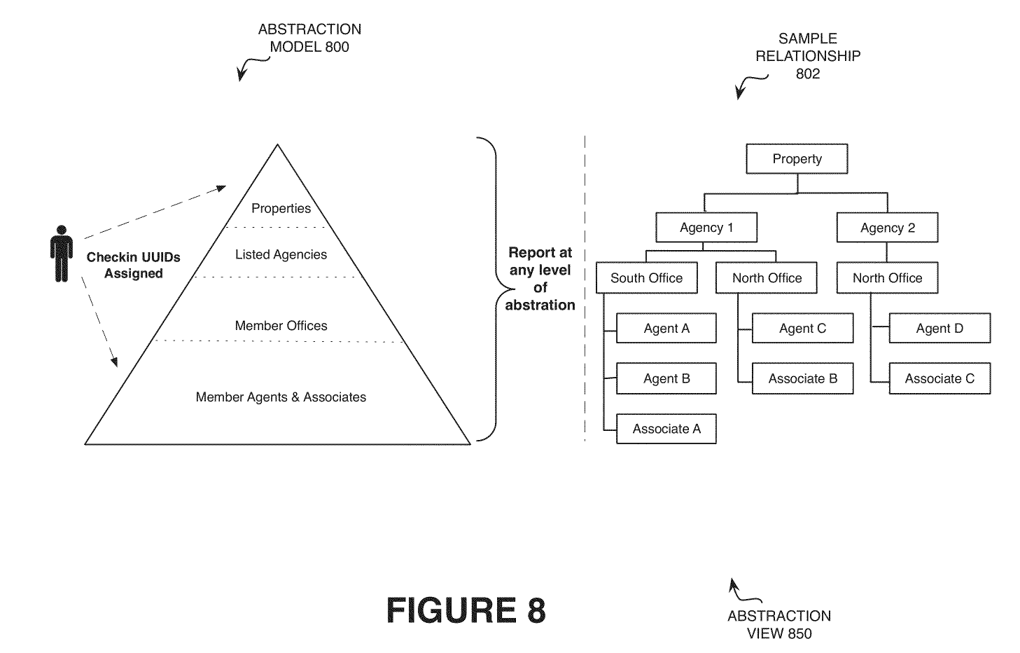

The agent 116 may be an individual who sells and/or rents real property 118 for clients. The agent 116 may be associated with a real estate agency. In various embodiments, the agent 116 may also refer to an entity or group of individuals, such as listed agencies, member offices, and member agents and/or associates. See, for example, FIG. 8.

The property 118 may be fixed property, such as land and/or buildings. The beacon 120 may be a device which may provide, passively and/or actively, identifying information through signals detectable by the prospect and agent clients. In some embodiments, the beacon 120 (and clients 102 and 104) may make use of standardized radio-based technologies, such as Bluetooth, Wi-Fi (e.g. mobile broadcasters/receivers, access points, etc.), radio-frequency identification (RFID), near field communication (NFC), and/or low power variations (e.g. Bluetooth LE, BluetoothSmart, etc.). In other embodiments, the beacon 120 (and clients 102 and 104) may make use of signal mediums other than radio, such as light and/or sound. In still other embodiments, the beacon 120 (and clients 102 and 104) may make use geo-location through GPS, cellular network towers, and/or observable Wi-Fi access points.

The predictive engine 124 may be software and/or hardware which may create, refine, and/or apply a statistical model based upon a collection of variables (e.g. data). The property profile 126 may be a collection of information associated with a property. The prospect profile 128 may be a collection of information associated with a prospect. The set of geo-spatial coordinates 130 may be a set of coordinates describing a particular location. They may be determined using any of a variety of geo-spatial location methods, including, but not limited to, GPS, cellular network towers, and Wi-Fi access points. The processor 132 may be a central processor unit (CPC) that may carry out the instructions of a computer program by performing the basic arithmetical, logical, and/or input/output operations of a computing system. The memory 134 may be physical devices used to store programs (sequences of instructions) and/or data (e.g. program state information) on a temporary and/or permanent basis for use in a computer or other digital electronic device.

The realty interaction server 100 is communicatively coupled with the prospect client 102, the agent client 104, the third party servers 108, the CRM system 110, and the property service provider server 112 through a network 106. The realty interaction server 100 may include a processor 132 communicatively coupled with a memory 134 and with a predictive engine 124. The processor 132 and the memory 134 may further be communicatively coupled to a database 122. The database 122 may include a property profile 126 and a prospect profile 128. In one embodiment, the prospect agent 116 may be communicatively coupled with the agent client 104 and a beacon 120 through direct radio communication (e.g. Bluetooth handshake, RFID tag identification, iBeacon broadcast, etc.).

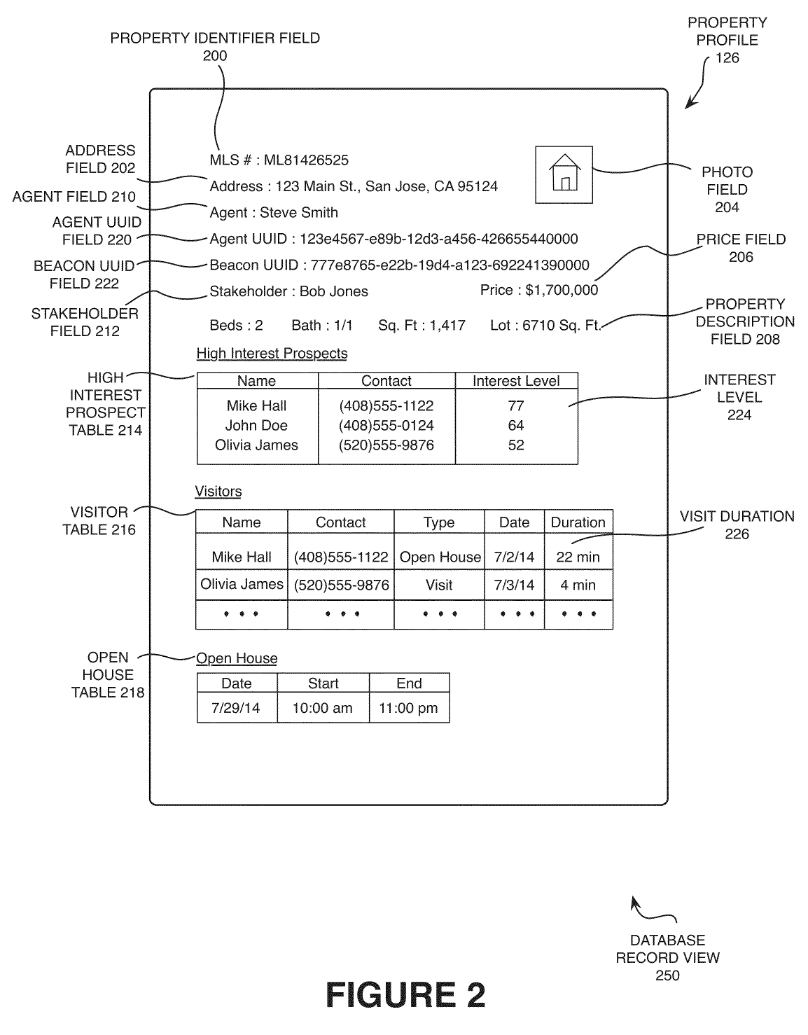

In one embodiment, a method of a realty interaction server 100 creates a profile of a property 118 in a database 122, using a processor 132 and a memory 134. The property profile 126 includes a property identifier (e.g. property identifier field 200 of FIG. 2), an address, a photo, a list of high interest prospects, and a list of visitors. The method includes associating the property profile 126 with an agent 116, and creating a profile of a prospect in the database 122. The method further includes automatically populating the prospect profile 128 by querying a third party server 108 through a network 106 using the prospect's phone number and the prospect's email address. In accordance with one embodiment, the prospect profile 128 includes a name, an employer, the phone number, the email address, an educational institution, a potential reference, a lending institution, a loan pre-approval, an age, a photo, a list of properties visited, a list of property profiles viewed, and a list of open houses attended.

In one embodiment, the method determines that the agent 116 is holding an open house at the property 118 and that an agent client 104 is broadcasting an agent UUID. The method includes processing the agent UUID detected by a prospect client 102, and notifying the agent client 104 and the prospect client 102 that the prospect has successfully checked in to the open house. The method includes communicating at least a portion of the prospect profile 128 to the agent client 104, as well as communicating at least a portion of the property profile 126 to the prospect client 102.

The method also includes updating the list of high interest prospects associated with the property profile 126 using a predictive engine 124. The predictive engine 124 populates the list of high interest prospects by quantifying an interest level of a prospect based upon a number of times the prospect has visited the property, an amount of time spent at the property 118 in an open house, a number of other properties visited, a location of other properties visited, a number of property profiles viewed, a ratio of properties viewed through the prospect client 102 to the number of properties visited, and whether the property 118 is being followed by the prospect.

In one embodiment, the method communicates the list of high interest prospects to the agent client 104, and records when the prospect has left the open house in the database 122. The prospect is a potential buyer and a potential renter. The prospect client 102 is a realty interaction client associated with the prospect, and the agent client 104 is a realty interaction client associated with the agent 116.

As a specific example of one embodiment, a prospect named James may be looking to purchase a home closer to his job. He had provided his email address to the realty interaction server 100, which automatically populated a prospect profile 128 with publicly available information obtained from social networks. An agent named Richard has scheduled an open house for a property 118 which Fred is interested in. At the start of the open house, Richard's mobile phone (e.g. a realty interaction client associated with an agent 116, also known as an agent client 104) begins broadcasting an agent UUID associated with Richard.

As James approaches the property, his mobile phone (e.g. a realty interaction client associated with a prospect, also known as a prospect client 102) detects Richard's agent UUID. The prospect client 102 transmits the agent UUID to the realty interaction server 100, which then notifies James and Richard that James has checked into the open house. James is presented with information about the property 118 through his prospect client 102, and Richard is presented with a profile of James. Furthermore, the realty interaction server 100 updates a list of high interest prospects associated with the property, to consider Fred. Based upon Fred's house hunting activities in the past, the realty interaction server 100 determines that he is a high interst prospect, and is added to the list. Richard is informed that a high interest prospect has entered the open house, and is presented with a photo of James.

The method may include associating a beacon UUID (e.g. the beacon UUID field 222 of FIG. 2) of a beacon 120 with the property profile 126. The method may further include processing a beacon UUID (e.g. the beacon UUID field 222 of FIG. 2) detected by the prospect client 102 and a current beacon location. The current beacon location may be a set of geo-spatial coordinates 130 captured through the prospect client 102 when the beacon UUID (e.g. the beacon UUID field 222 of FIG. 2) was detected. The method may validate the current beacon location by comparing the current beacon location with the property profile 126.

The method may include notifying the agent 116 associated with the property profile 126 when the current beacon location is inconsistent with the property profile 126. The prospect profile 128 and/or the property profile 126 may be updated with a property visit when the current beacon location is consistent with the property profile 126. The method may also include communicating at least a portion of the property profile 126 to the prospect client 102. The predictive engine 124 may populate the list of high interest prospects based further upon a number of times the prospect has visited the property 118 while the agent 116 was not present.

As a specific example, in one embodiment, James is looking at different houses for sale in the evening, after work. He approaches a home that is associated with an agent named Shelly. The “For Sale” sign at the home includes a beacon 120, which is broadcasting a beacon UUID (e.g. the beacon UUID field 222 of FIG. 2) that has been associated with the property. As James approaches the property, his prospect client 102 detects the beacon UUID (e.g. the beacon UUID field 222 of FIG. 2), and transmits the UUID and the current GPS coordinates to the realty interaction server 100 for validation. The server determines that the beacon 120 is where it is supposed to be by comparing the property address with the GPS coordinates. The server sends detailed information about the property 118 to James' prospect client 102, and makes note of the visit in both James' prospect profile 128 and the property profile 126.

The method may include providing a CRM system 110 with information comprising at least a portion of the property profile 126, and/or at least a portion of the prospect profiles 128 of prospects who have visited the property. The CRM system 110 may be a database 122 associated with the agent 116.

The method may process a request from the prospect client 102, communicate at least a portion of the request to a property service provider server 112, and/or report a response to the request to the prospect client 102. The request may include a rental application, a loan approval application, a home inspection request, a home appraisal request, and/or a utility installation request. The response may include an appointment confirmation, a home inspection report, a home appraisal report, and/or a loan approval.

The method may include communicating to a stakeholder at least a portion of the property profile 126, the list of high interest prospects, and/or at least a portion of the prospect profile 128. The stakeholder may be an owner of the property 118 and/or an investor. The prospect may opt out of sharing at least a portion of the prospect profile 128 with the agent 116. The third party server 108 may be a social network.

FIG. 2 shows a database record view 250 of a property profile 126 of the database 122 of FIG. 1, according to one embodiment. Particularly, the database record view 250 of the property profile 126 illustrates a property identifier field 200, an address field 202, a photo field 204, a price field 206, a property description field 208, an agent field 210, a stakeholder field 212, a high interest prospect table 214, a visitor table 216, an open house table 218, an agent UUID field 220, a beacon UUID field 222, an interest level 224, and a visit duration 226.

The property identifier field 200 may contain an identifier associated with the property. In one embodiment, the property identifier field 200 may contain a Multiple Listing Service (MLS) number assigned to the property. In other embodiments, the property identifier field may contain a similar number, associated with a listing service, agent, CRM, or property portal. The address field 202 may contain the address of the property. The photo field 204 may contain one or more photos of the property. The photo field 204 may contain the binary data which makes up the photo and/or may contain a link or address to where one or more photos are stored. The price field 206 may contain a current asking price and/or rent for the property.

The property description field 208 may contain text describing the property. In one embodiment, the property description field 208 may contain information such as the number of bedrooms/bathrooms, the area of the property 118 interior/exterior, paint color, landscape features, and/or any other information which may describe real property. The agent field 210 may contain an identifier of the agent 116 associated with the property. In one embodiment, the agent field 210 may contain the name of the agent 116. The stakeholder field 212 may contain an identifier of one or more stakeholders associated with the property. In the context of the present description, a stakeholder may refer to an owner of the property, an investor, and/or any individual or group who has a financial and/or ownership interest in the property.

The high interest prospect table 214 may contain information associated with prospects who have been determined to have a high level of interest in the property, and/or fit a profile of a likely buyer/renter. In one embodiment, the interest level 224 of a prospect may be quantified using the predictive engine 124. The visitor table 216 may contain information associated with prospects who have visited the property 118 at some point. In accordance with one embodiment, the visitor table 216 may contain a record of who has visited the property, whether the visit was during an open house or at another time, when the visit happened, the duration of the visit. The open house table 218 may contain information concerning previous and/or planned open houses at the property. In the context of the present description, an open house may be an occasion when real estate being offered for sale and/or rent can be viewed by prospective buyers and/or renters without an appointment.

The agent UUID field 220 may contain a universally unique identifier (UUID) associated with the agent 116 and/or the agent client 104. In various embodiments, the agent UUID may be a 128-bit number. The agent UUID may be assigned to the agent 116 and/or agent client 104 in a way that minimizes the probability that duplicate UUIDs will be in use in a way that would result in a conflict. The beacon UUID field 222 may contain a UUID associated with the beacon 120. In one embodiment, this may be related to the type of technology used to broadcast identifying information. The interest level may be a quantified indication of the level of interest a prospect has for a property 118 and/or their potential to be the ultimate purchaser/renter of the property. The visit duration 226 may refer to a length of time spent visiting a property, either during an open house, or at another time.

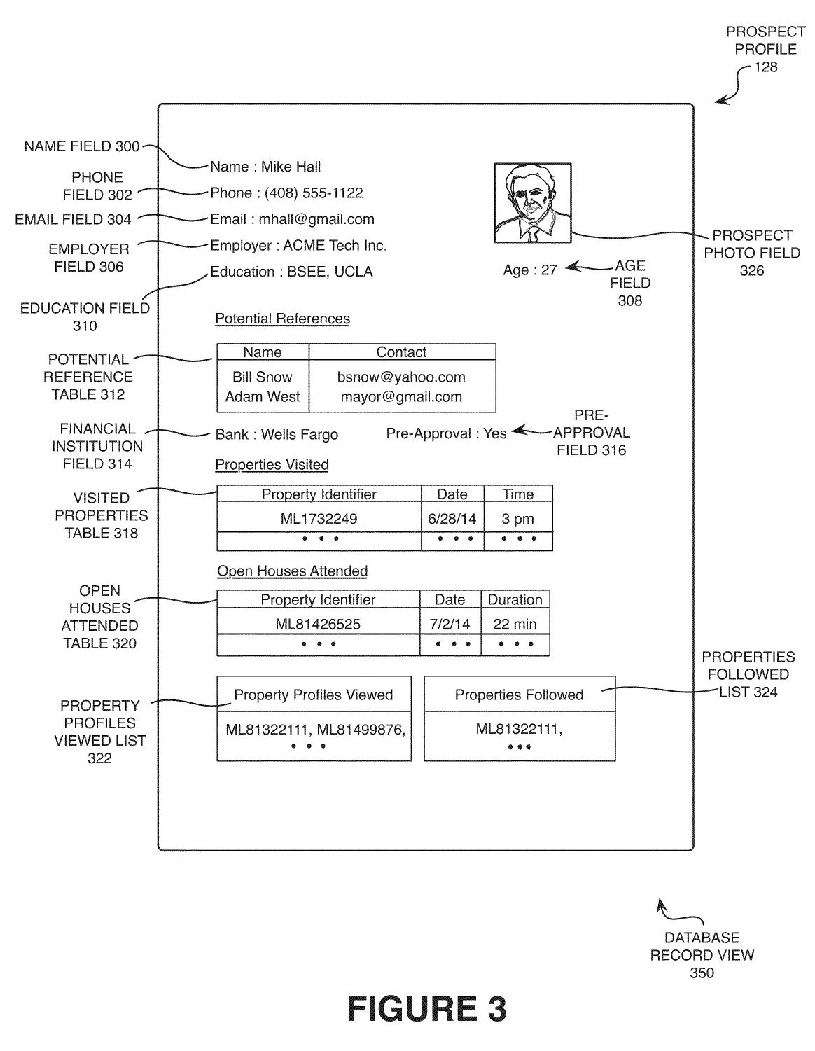

FIG. 3 shows a database record view 350 of a prospect profile 128 of the database 122 of FIG. 1, according to one embodiment. Particularly, the database record view 350 of the prospect profile 128 illustrates a name field 300, a phone field 302, an email field 304, a prospect photo field 326, an employer field 306, an age field 308, an education field 310, a potential reference table 312, a financial institution field 314, a pre-approval field 316, a visited properties table 318, an open houses attended table 320, a property profiles viewed list 322, and a properties followed list 324.

The name field 300 may contain the name of the prospect. The phone field 302 may contain a phone number associated with the prospect. The email field 304 may contain an email address associated with the prospect. The prospect photo field 326 may contain a photo of the prospect. The employer field 306 may contain the name of the prospect's current employer. The age field 308 may contain the age and/or birthdate of the prospect. The education field 310 may contain information concerning the educational background of the prospect. The potential reference table 312 may contain information associated with individuals who may be potential references for the prospect. The table may contain names and/or contact information for each potential reference.

The financial institution field 314 may contain the name of a financial institution associated with the prospect and which may become involved in a property 118 transaction. The pre-approval field 316 may contain information regarding whether or not the prospect has been pre-approved for a loan and/or the amount that the prospect has been pre-approved to borrow for a property 118 purchase. The visited properties table 318 may contain information associated with the properties the prospect has visited in the past. The table may contain information such as a property identifier (e.g. property identifier field 200 of FIG. 2), the date of a visit, and the time of the visit. The open houses attended table 320 may contain information associated with the property 118 open houses the prospect has attended in the past. The table may contain information such as a property identifier (e.g. property identifier field 200 of FIG. 2), the date of the open house, and how long the prospect was present at the open house.

The property profiles viewed list 322 may contain a list of the properties the prospect has viewed using the prospect client 102 and/or any other computer device. The properties followed list 324 may contain a list of properties which the prospect wishes to monitor. In one embodiment, the prospect may be notified of any change in status of a followed property 118 (e.g. asking price change, taken off the market, sold, new open house scheduled, new photos, etc.).

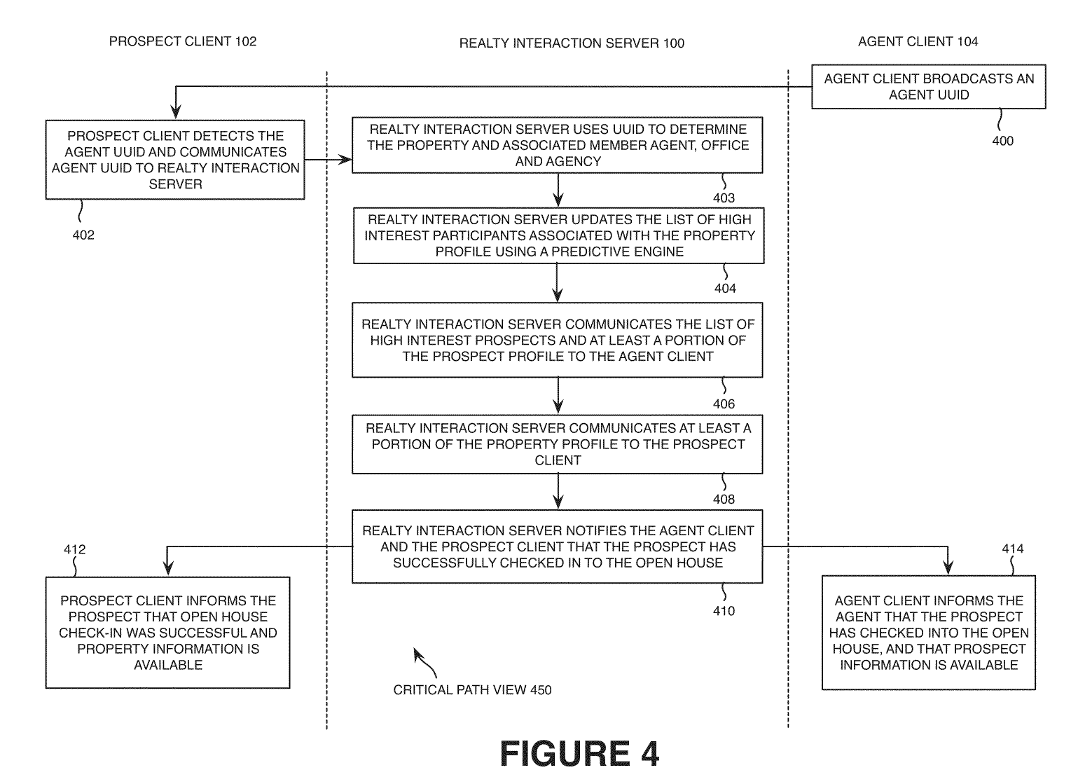

FIG. 4 is a critical path view 450 of an open house check-in interaction between the prospect client 102, the agent client 104, and the realty interaction server 100 of FIG. 1, according to one embodiment. In operation 400, the agent client 104 may broadcast an agent UUID. In operation 402, the prospect client 102 may detect the agent UUID and communicates the agent UUID to realty interaction server 100. In operation 403, the realty interaction server may use the agent UUID to determine the property being visited, and the associated member agent, office and/or agency. In the context of the present description, a member agent, office, and agency may refer to levels of a management hierarchy which may be involved in the sale and/or rental of the property. See, for example, FIG. 8. Then, in operation 404, the realty interaction server 100 may update the list of high interest participants associated with the property profile 126 using the predictive engine 124.

This list may then be communicated to the agent client 104 in operation 406. Particularly, in operation 406, the realty interaction server 100 may communicate the list of high interest prospects and at least a portion of the prospect profile 128 to the agent client 104. Next, in operation 408, the realty interaction server 100 may communicate at least a portion of the property profile 126 to the prospect client 102.

In operation 410, the realty interaction server 100 may notify the agent client 104 and the prospect client 102 that the prospect has successfully checked in to the open house. Then, in operation 412, the prospect client 102 may inform the prospect that open house check-in was successful and property information is available. Furthermore, in operation 414, the agent client 104 may inform the agent 116 that the prospect has checked into the open house, and that prospect information is available.

In various embodiments, open house check-in activity, such as that described by FIG. 4, may be recorded and made available through the realty interaction server to agent clients associated with member agents, offices, and agencies which have some form of relationship to the property.

The open-house check-in interaction depicted in FIG. 4 may occur automatically, according to one embodiment. In other embodiments, the prospect may be prompted as to whether or not they wish to check-in, once the agent UUID has been detected. In still other embodiments, the prospect may have the option to check-in, but may not be prompted to do so.

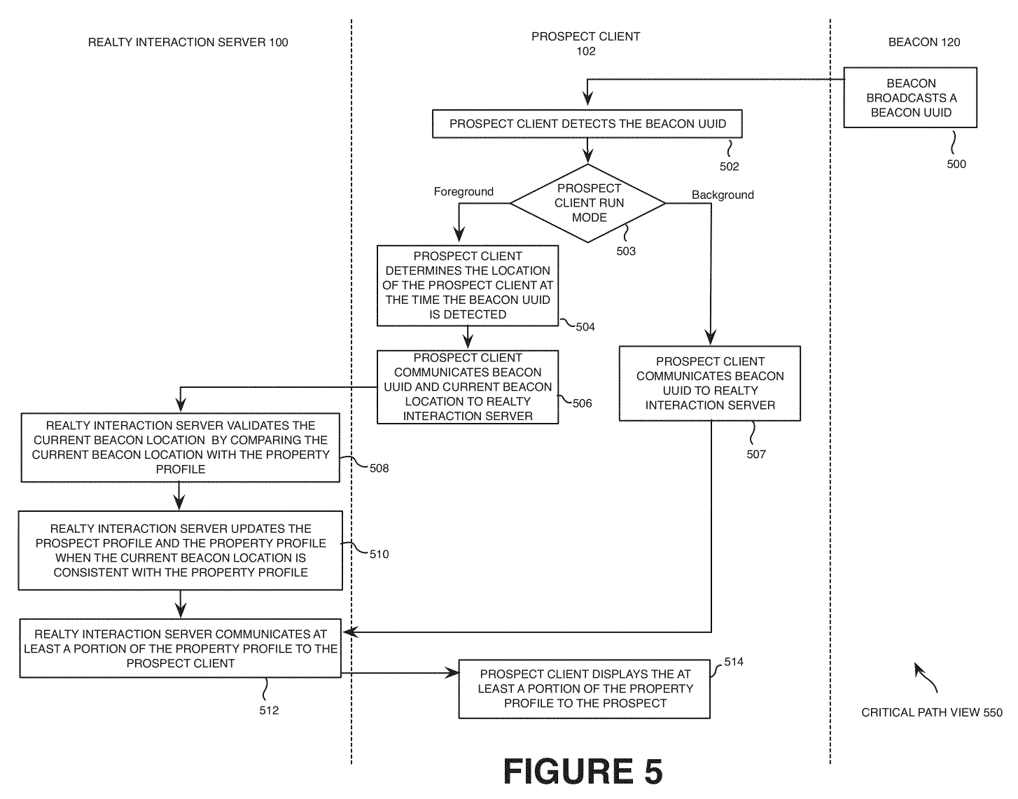

FIG. 5 is a critical path view 550 of an automatic visit registration interaction between a beacon 120, the prospect client 102 of FIG. 1, and the realty interaction server 100 of FIG. 1, according to one embodiment. First, in operation 500, the beacon 120 may broadcast a beacon UUID (e.g. the beacon UUID field 222 of FIG. 2). Then, in operation 502, the prospect client 102 may detect the beacon UUID (e.g. the beacon UUID field 222 of FIG. 2). In determination 503, it may be determined what mode the prospect client 102 is in, whether it is running in a foreground mode or a background mode. In various embodiments, running in a foreground mode may refer to a mode where the prospect 114 is being presented with a user interface, and is able to interact with the prospect client 102. Additionally, running in a background mode may refer to a mode where the prospect client 102 is not being used by the prospect 114, but is still running a realty interaction client, whether the device screen is active or not. As a specific example, a prospect client 102 being used to search for a property may be in a foreground mode, while a prospect client 102 which is in a prospect's pocket or bag may be in a background mode.

If it is determined that the prospect client 102 is running in a foreground mode, the prospect client 102 may determine the location of the prospect client 102 at the time the beacon UUID (e.g. the beacon UUID field 222 of FIG. 2) is detected. See operation 504. In operation 506, the prospect client 102 may communicate the beacon UUID (e.g. the beacon UUID field 222 of FIG. 2) and the current beacon location to the realty interaction server 100.

In operation 508, the realty interaction server 100 may validate the current beacon location by comparing the current beacon location with the property profile 126. In operation 510, the realty interaction server 100 may update the prospect profile 128 and the property profile 126 when the current beacon location is consistent with the property profile 126. If it is determined in operation 503 that the prospect client 102 is running in a background mode, then the prospect client 102 may communicate the beacon UUID (e.g. the beacon UUID field 222 of FIG. 2) to the realty interaction server 100. See operation 507.

In operation 512, the realty interaction server 100 may communicate at least a portion of the property profile 126 to the prospect client 102. Finally, in operation 514, the prospect client 102 may display the at least a portion of the property profile 126 to the prospect.

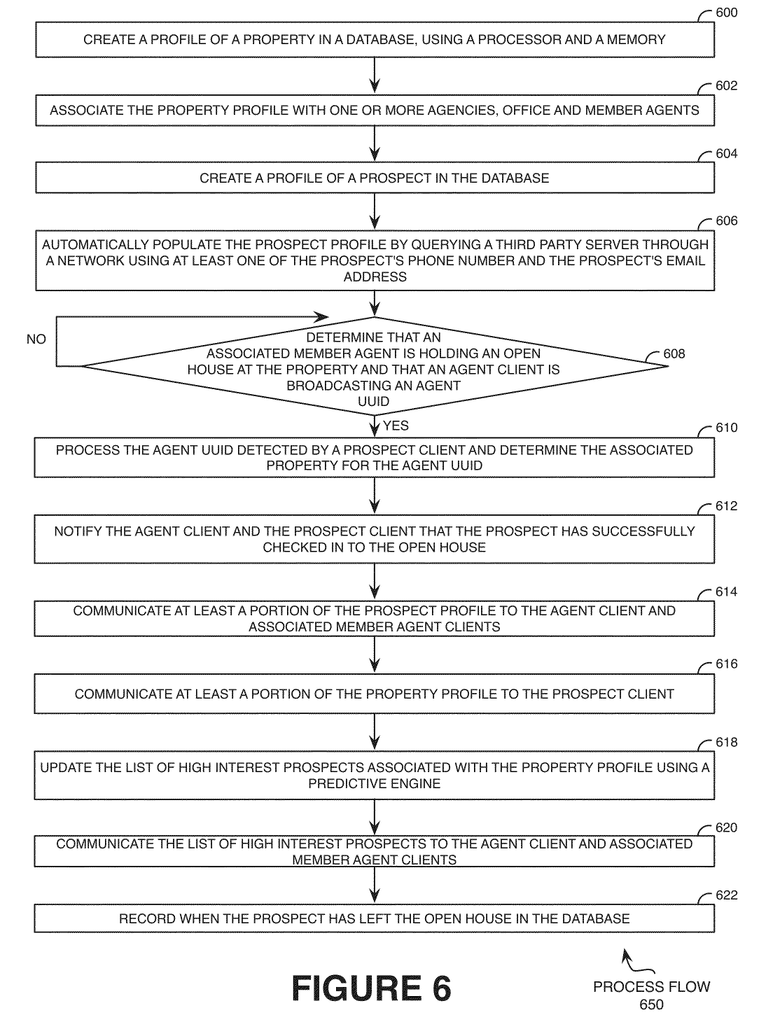

FIG. 6 is a process flow 650 to notify the agent client 104 of FIG. 1 that a prospect has checked in at an open house, according to one embodiment. In operation 600, a profile of a property 118 may be created in a database 122, using a processor 132 and a memory 134. In operation 602, the property profile 126 may be associated with an agent 116 and/or one or more agencies, offices, and/or member agents. Next, in operation 604, a profile of a prospect may be created in the database 122. Subsequently, in operation 606, the prospect profile 128 may be automatically populated by querying a third party server 108 through a network 106 using at least one of the prospect's phone number and the prospect's email address. In various embodiments, the prospect profile 128 may be automatically populated using information obtained from a third party servers 108, such as a social network (e.g. Facebook, LinkedIn, etc.) using the prospect's phone number and/or email. In another embodiment, the realty interaction server 100 may scrape data from a plurality of third party servers 108 to populate the prospect profile 128.

In operation 608, it may be determined whether the agent 116 or associated member agent is holding an open house at the property 118 and whether an agent client 104 is broadcasting an agent UUID. A loop pattern may be entered until an agent client 104 is broadcasting an agent UUID at an open house. In one embodiment, the agent 116 may indicate they are present at an open house using the agent client 104. As an option, the realty interaction server 100 may publish and/or issue notifications to interested prospects regarding a spontaneous open house triggered by the agent 116 through the agent client 104. In another embodiment, the open house may be scheduled. When the agent client 104 is broadcasting an agent UUID at an open house, the agent UUID detected by a prospect client 102 may be processed. See operation 610.

Next, in operation 612, the agent client 104 and the prospect client 102 may both be notified that the prospect has successfully checked in to the open house. In operation 614, at least a portion of the prospect profile 128 may be communicated to the agent client 104 and/or one or more associated member agent clients. Furthermore, in operation 616, at least a portion of the property profile 126 may be communicated to the prospect client 102. In some embodiments, operations 614 and 616 may be performed in parallel.

Next, the list of high interest prospects associated with the property profile 126 may be updated using a predictive engine 124 in operation 618. In operation 620, the list of high interest prospects may be communicated to the agent client 104 and/or one or more associated member agent clients. Finally, in operation 622, the time when the prospect has left the open house may be recorded in the database 122.

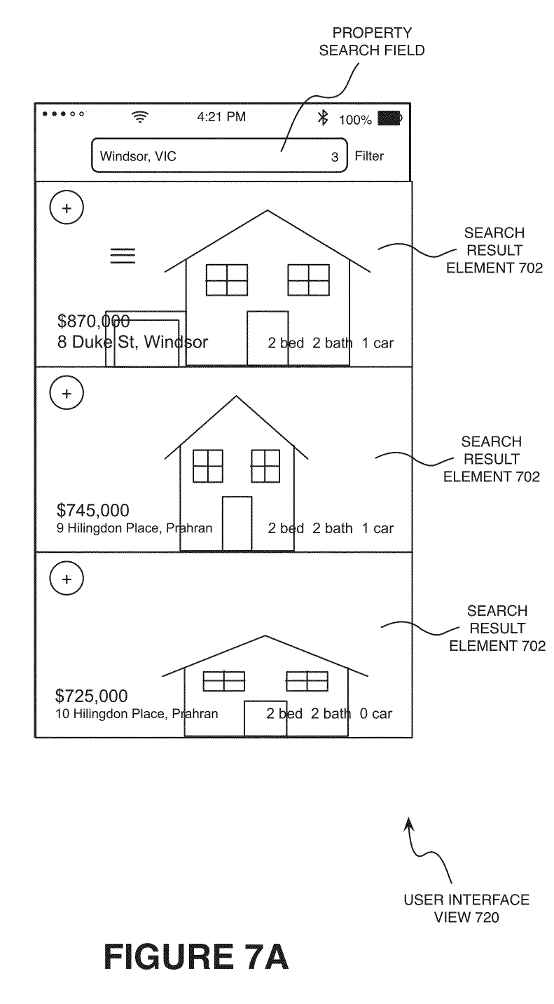

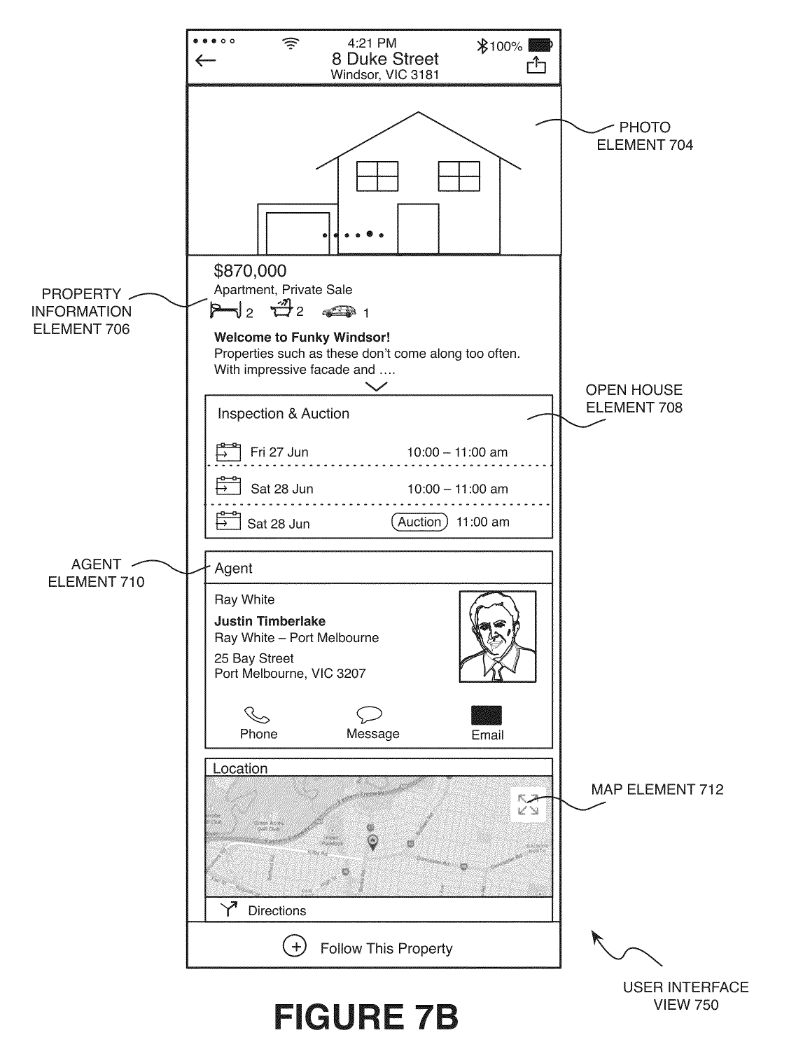

FIG. 7A is a user interface view 720 of a property search performed through a realty interaction client, according to one embodiment. Particularly, user interface view 720 shows a property search field 700 and a plurality of search result elements 702. A user of the realty interaction client (e.g. a prospect, an agent 116, a stakeholder, etc.) may enter a search term into the property search field 700. In various embodiments, search terms may include, but are not limited to, a city, a street, a neighborhood, a school district, a price range, an age of the structure, a number of bedrooms, a number of bathrooms, an area of interior floor space, an area of the lot, a parking capacity, an asking price/rent, a pet policy, a landscape feature (e.g. garden, pool, etc.), and/or any other type of information associated with a property. As an option, a search may be performed using multiple terms.

In various embodiments, the results of a property search may be displayed using one or more search result elements 702. As shown, a search result element 702 may comprise a photo of the property, overlaid with pieces of information associated with the property. In one embodiment, the overlaid information may be static, independent of the search performed. For example, the search result element 702 may statically display an asking price, a street address, a number of bed and bathrooms, and parking capacity. In another embodiment, the overlaid information may be specific to the search performed. For example, if a search was performed based on when the home was built (e.g. 10 years old or newer, etc.), the search result elements 702 may be overlaid with the age of the home. In various embodiments, selecting (e.g. clicking, touching, tapping, etc.) on a search result element 702 may display a property summary such as the one illustrated in FIG. 7B.

FIG. 7B is a user interface view 750 of a property summary associated with a search result of FIG. 7A as displayed through a realty interaction client, according to one embodiment. Particularly, user interface view 750 shows a photo element 704, a property information element 706, an open house element 708, an agent element 710, and a map element 712. The photo element 704 may present one or more photographs of the property, in accordance with one embodiment. As an option, the user may be able to resize the photo, or cycle between multiple photos. The property information element 706 may contain at least a portion of the property profile 126. In various embodiments, the information displayed in the property information element 706 may depend upon the identity of the user of the realty interaction client. For example, a prospect may only be shown basic information (e.g. price, property type, size, description, etc.), while an agent 116 or stakeholder may be presented with additional information such as open house turnout, a list of high interest prospects, and/or any other information associated with the sale/leasing of the property.

The open house element 708 may contain a list of open houses scheduled for the property. As an option, the user may have the option of selecting an open house and having the details added to their personal calendar automatically. In another embodiment, the open house element 708 may also list an upcoming auction through which the property 118 will be available.

The agent element 710 may display information concerning the agent 116 associated with the property. For example, the agent element 710 may contain the agent name, a photo of the agent 116, a real estate agency, an office address, and at least one method of communication (e.g. phone, email, text message, social network, etc.). The map element 712 may display the location of the property 118 in a geographic context. In one embodiment, the user may be able to resize the map displayed in the map element 712. In another embodiment, the user may request driving directions from a location to the property 118 through the map element 712. In yet another embodiment, the map element 712 may also display estimated travel times to one or more predefined locations, such as the user's place of employment or school.

FIG. 8 is an abstraction view of an agency hierarchy which may reflected in assigned UUIDs, according to one embodiment. Particularly, FIG. 8 illustrates an abstraction model 800 and a sample relationship 802. In various embodiments, a variety of individuals and entities may be involved in the sale and/or rental of a property. These individuals and entities may be arranged in an organization hierarchy, such as that shown in sample relationship 802. Each of these individuals or entities may wish to receive up-to-date information concerning a property with which they are associated (e.g. open house status, high interest prospect list, offers made, prospects who have visited the property, etc.). The agent UUID used at an open house for check-in purposes may be associated with a particular level of a hierarchy, such that levels which are higher and/or lower may automatically receive reporting, in accordance with one embodiment. In some embodiments, the UUID assigned to an agent may indicate a position within a hierarchy; in other embodiments, the UUID assigned to an agent may be randomized, yet still associated with a position within a hierarchy by the realty interaction server.

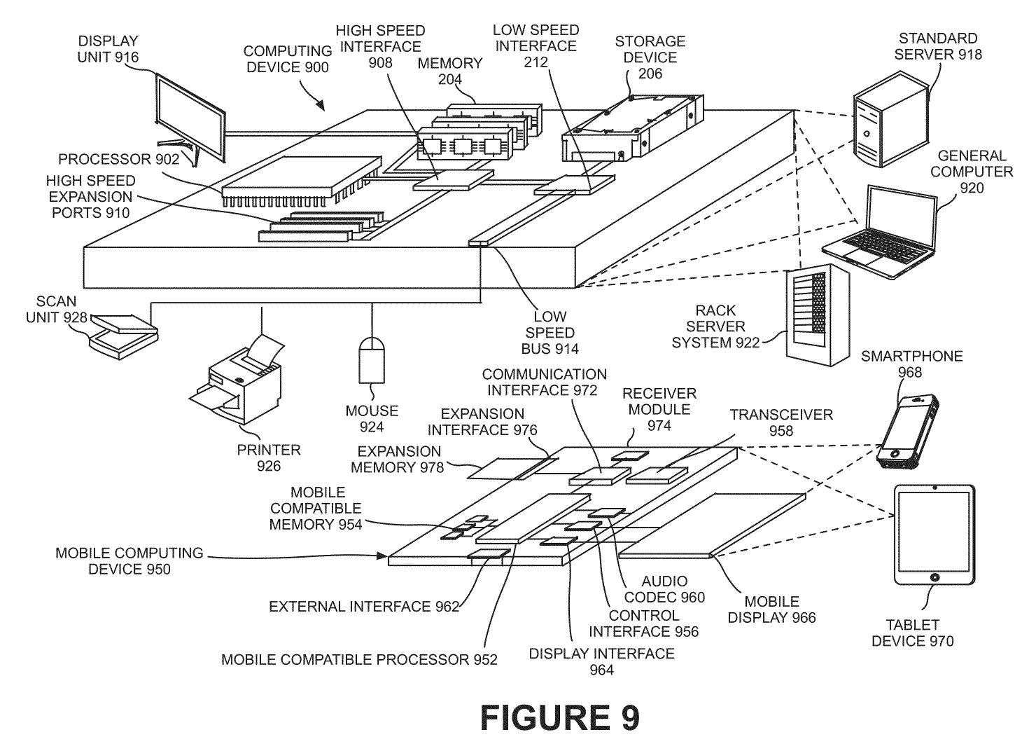

FIG. 9 is a schematic of a computing device 900 and a mobile device 950 that can be used to perform and/or implement any of the embodiments disclosed herein. In one or more embodiments, any of the realty interaction server 100, the third party servers 108, the CRM system 110, and/or the property service provider server 112 may be the computing device 900. In addition, the agent client 104 and/or the prospect client 102 may be either the computing device 900 or the mobile device 950.

The computing device 900 may represent various forms of digital computers, such as laptops, desktops, workstations, personal digital assistants, servers, blade servers, mainframes, and/or other appropriate computers. The mobile device 950 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed.

The computing device 900 may include a processor 902, a memory 904, a storage device 906, a high speed interface 908 coupled to the memory 904 and a plurality of high speed expansion ports 910, and a low speed interface 912 coupled to a low speed bus 914 and a storage device 906. In one embodiment, each of the components heretofore may be inter-coupled using various buses, and may be mounted on a common motherboard and/or in other manners as appropriate. The processor 902 may process instructions for execution in the computing device 900, including instructions stored in the memory 904 and/or on the storage device 906 to display a graphical information for a GUI on an external input/output device, such as a display unit 916 coupled to the high speed interface 908. In other embodiments, multiple processors and/or multiple buses may be used, as appropriate, along with multiple memories and/or types of memory. Also, a plurality of computing devices 900 may be coupled with, with each device providing portions of the necessary operations (e.g., as a server bank, a group of blade servers, and/or a multi-processor system).

The memory 904 may be coupled to the computing device 900. In one embodiment, the memory 904 may be a volatile memory. In another embodiment, the memory 904 may be a non-volatile memory. The memory 904 may also be another form of computer-readable medium, such as a magnetic and/or an optical disk. The storage device 906 may be capable of providing mass storage for the computing device 900. In one embodiment, the storage device 906 may be comprised of at least one of a floppy disk device, a hard disk device, an optical disk device, a tape device, a flash memory and/or other similar solid state memory device. In another embodiment, the storage device 906 may be an array of the devices in a computer-readable medium previously mentioned heretofore, computer-readable medium, such as, and/or an array of devices, including devices in a storage area network and/or other configurations.

A computer program may be comprised of instructions that, when executed, perform one or more methods, such as those described above. The instructions may be stored in at least one of the memory 904, the storage device 906, a memory coupled to the processor 902, and/or a propagated signal.

The high speed interface 908 may manage bandwidth-intensive operations for the computing device 900, while the low speed interface 912 may manage lower bandwidth-intensive operations. Such allocation of functions is exemplary only. In one embodiment, the high-speed interface 908 may be coupled to at least one of the memory 904, the display unit 916 (e.g., through a graphics processor and/or an accelerator), and to the plurality of high speed expansion ports 910, which may accept various expansion cards. In the embodiment, the low speed interface 912 may be coupled to at least one of the storage device 906 and the low-speed bus 914. The low speed bus 914 may be comprised of a wired and/or wireless communication port (e.g., a Universal Serial Bus (“USB”), a Bluetooth® port, an Ethernet port, and/or a wireless Ethernet port). The low speed bus 914 may also be coupled to at least one of scan unit 928, a printer 926, a keyboard, a mouse 924, and a networking device (e.g., a switch and/or a router) through a network adapter.

The computing device 900 may be implemented in a number of different forms, as shown in the Figure. In one embodiment, the computing device 900 may be implemented as a standard server 918 and/or a group of such servers. In another embodiment, the computing device 900 may be implemented as part of a rack server system 922. In yet another embodiment, the computing device 900 may be implemented as a general computer 920 such as a laptop or desktop computer. Alternatively, a component from the computing device 900 may be combined with another component in a mobile device 950. In one or more embodiments, an entire system may be made up of a plurality of computing devices 900 and/or a plurality of computing devices 900 coupled to a plurality of mobile devices 950.

In one embodiment, the mobile device 950 may comprise at least one of a mobile compatible processor 952, a mobile compatible memory 954, and an input/output device such as a mobile display 966, a communication interface 972, and a transceiver 958, among other components. The mobile device 950 may also be provided with a storage device, such as a microdrive or other device, to provide additional storage. In one embodiment, at least one of the components indicated heretofore are inter-coupled using various buses, and several of the components may be mounted on a common motherboard.

The mobile compatible processor 952 may execute instructions in the mobile device 950, including instructions stored in the mobile compatible memory 954. The mobile compatible processor 952 may be implemented as a chipset of chips that include separate and multiple analog and digital processors. The mobile compatible processor 952 may provide, for example, for coordination of the other components of the mobile device 950, such as control of user interfaces, applications run by the mobile device 950, and wireless communication by the mobile device 950.

The mobile compatible processor 952 may communicate with a user through the control interface 956 and the display interface 964 coupled to a mobile display 966. In one embodiment, the mobile display 966 may be at least one of a Thin-Film-Transistor Liquid Crystal Display (“TFT LCD”), an Organic Light Emitting Diode (“OLED”) display, and another appropriate display technology. The display interface 964 may comprise appropriate circuitry for driving the mobile display 966 to present graphical and other information to a user. The control interface 956 may receive commands from a user and convert them for submission to the mobile compatible processor 952. In addition, an external interface 962 may be provide in communication with the mobile compatible processor 952, so as to enable near area communication of the mobile device 950 with other devices. External interface 962 may provide, for example, for wired communication in some embodiments, or for wireless communication in other embodiments, and multiple interfaces may also be used.

The mobile compatible memory 954 may be coupled to the mobile device 950. The mobile compatible memory 954 may be implemented as at least one of a volatile memory and a non-volatile memory. The expansion memory 978 may also be coupled to the mobile device 950 through the expansion interface 976, which may comprise, for example, a Single In Line Memory Module (“SIMM”) card interface. The expansion memory 978 may provide extra storage space for the mobile device 950, or may also store an application or other information for the mobile device 950. Specifically, the expansion memory 978 may comprise instructions to carry out the processes described above. The expansion memory 978 may also comprise secure information. For example, the expansion memory 978 may be provided as a security module for the mobile device 950, and may be programmed with instructions that permit secure use of the mobile device 950. In addition, a secure application may be provided on the SIMM card, along with additional information, such as placing identifying information on the SIMM card in a non-hackable manner.

The mobile compatible memory 952 may comprise at least one of a volatile memory (e.g., a flash memory) and a non-volatile memory (e.g., a non-volatile random-access memory (“NVRAM”)). In one embodiment, a computer program comprises a set of instructions that, when executed, perform one or more methods. The set of instructions may be stored on at least one of the mobile compatible memory 954, the expansion memory 978, a memory coupled to the mobile compatible processor 952, and a propagated signal that may be received, for example, over the transceiver 958 and/or the external interface 962.

The mobile device 950 may communicate wirelessly through the communication interface 972, which may be comprised of a digital signal processing circuitry. The communication interface 972 may provide for communications using various modes and/or protocols, such as, at least one of: a Global System for Mobile Communications (“GSM”) protocol, a Short Message Service (“SMS”) protocol, an Enhanced Messaging System (“EMS”) protocol, a Multimedia Messaging Service (“MMS”) protocol, a Code Division Multiple Access (“CDMA”) protocol, Time Division Multiple Access (“TDMA”) protocol, a Personal Digital Cellular (“PDC”) protocol, a Wideband Code Division Multiple Access (“WCDMA”) protocol, a CDMA2000 protocol, and a General Packet Radio Service (“GPRS”) protocol. Such communication may occur, for example, through the radio-frequency transceiver 958. In addition, short-range communication may occur, such as using a Bluetooth®, Wi-Fi, and/or other such transceiver. In addition, a GPS (“Global Positioning System”) receiver module may provide additional navigation-related and location-related wireless data to the mobile device 950, which may be used as appropriate by a software application running on the mobile device 950.

The mobile device 950 may also communicate audibly using an audio codec 960, which may receive spoken information from a user and convert it to usable digital information. The audio codec 960 may likewise generate audible sound for a user, such as through a speaker (e.g., in a handset of the mobile device 950). Such a sound may comprise a sound from a voice telephone call, a recorded sound (e.g., a voice message, a music files, etc.) and may also include a sound generated by an application operating on the mobile device 950.

The mobile device 950 may be implemented in a number of different forms, as shown in the Figure. In one embodiment, the mobile device 950 may be implemented as a smartphone 968. In another embodiment, the mobile device 950 may be implemented as a personal digital assistant (“PDA”). In yet another embodiment, the mobile device, 950 may be implemented as a tablet device 970.

Various embodiments of the systems and techniques described here can be realized in at least one of a digital electronic circuitry, an integrated circuitry, a specially designed application specific integrated circuits (“ASICs”), a piece of computer hardware, a firmware, a software application, and a combination thereof. These various embodiments can include embodiment in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, and/or code) comprise machine-readable instructions for a programmable processor, and can be implemented in a high-level procedural and/or object-oriented programming language, and/or in assembly/machine language. As used herein, the terms “machine-readable medium” and/or “computer-readable medium” refers to any computer program product, apparatus and/or device (e.g., magnetic discs, optical disks, memory, and/or Programmable Logic Devices (“PLDs”)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computing device having a display device (e.g., a cathode ray tube (“CRT”) and/or liquid crystal display (“LCD”) monitor) for displaying information to the user and a keyboard and a mouse 924 by which the user can provide input to the computer. Other kinds of devices can be used to provide for interaction with a user as well; for example, feedback provided to the user can be any form of sensory feedback (e.g., visual feedback, auditory feedback, and/or tactile feed-back) and input from the user can be received in any form, including acoustic, speech, and/or tactile input.

The systems and techniques described here may be implemented in a computing system that comprises at least one of a back end component (e.g., as a data server), a middleware component (e.g., an application server), a front end component (e.g., a client computer having a graphical user interface, and/or a Web browser through which a user can interact with an embodiment of the systems and techniques described here), and a combination thereof. The components of the system may also be coupled through a communication network.

The communication network may comprise at least one of a local area network (“LAN”) and a wide area network (“WAN”) (e.g., the Internet). The computing system can comprise at least one of a client and a server. In one embodiment, the client and the server are remote from each other and interact through the communication network.

A number of embodiments have been described. Nevertheless, it will be understood that various modifications may be made without departing from the spirit and scope of the claimed invention. In addition, the logic flows depicted in the Figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the Figures may be shown as distinct and communicating with only a few specific structures and not others. The structures may be merged with each other, may perform overlapping functions, and may communicate with other structures not shown to be connected in the Figures. Accordingly, the specification and/or drawings may be regarded in an illustrative rather than a restrictive sense.

What is claimed is:

1. A method of a realty interaction server, comprising:
creating a property profile of a property in a database, using a processor and a memory;
wherein the property profile comprises a list of high interest prospects, a list of visitors, and at least one of a property identifier, an address, and a photo;
associating the property profile with an agent;
creating a prospect profile of a prospect in the database;
automatically populating the prospect profile by querying a third party server through a network using at least one of the prospect's phone number and the prospect's email address;
determining that the agent is holding an open house at the property and that an agent client is broadcasting an agent UUID;
processing the agent UUID detected by a prospect client;
notifying the agent client and the prospect client that the prospect has successfully checked in to the open house;
communicating at least a portion of the prospect profile to the agent client;
communicating at least a portion of the property profile to the prospect client;
updating the list of high interest prospects associated with the property profile using a predictive engine;
communicating the list of high interest prospects to the agent client; and
recording when the prospect has left the open house in the database,
wherein the prospect is at least one of a potential buyer and a potential renter,
wherein the prospect client is a realty interaction client associated with the prospect, and
wherein the agent client is a realty interaction client associated with the agent.

2. The method of claim 1, wherein the processing of the agent UUID detected by the prospect client is performed in response to the agent UUID being communicated to the realty interaction server automatically by the prospect client.

3. The method of claim 1, wherein the prospect profile comprises at least two of a name, an employer, the phone number, the email address, an educational institution, a potential reference, a lending institution, a loan pre-approval, an age, a photo, a list of properties visited, a list of property profiles viewed, and a list of open houses attended.

4. The method of claim 1, wherein the predictive engine populates the list of high interest prospects by quantifying an interest level of a prospect based upon at least one of: a number of times the prospect has visited the property, an amount of time spent at the property in an open house, a number of other properties visited, a location of other properties visited, a number of property profiles viewed, a ratio of properties viewed through the prospect client to the number of properties visited, and whether the property is being followed by the prospect.

5. The the method of claim 1, further comprising:
associating a beacon UUID of a beacon with the property profile;
processing a beacon UUID detected by the prospect client and a current beacon location,
wherein the current beacon location is a set of geo-spatial coordinates captured through the prospect client when the beacon UUID is detected;
validating the current beacon location by comparing the current beacon location with the property profile;
notifying the agent associated with the property profile when the current beacon location is inconsistent with the property profile;
updating the prospect profile and the property profile with a property visit when the current beacon location is consistent with the property profile; and
communicating at least a portion of the property profile to the prospect client,
wherein the predictive engine populates the list of high interest prospects based further upon a number of times the prospect has visited the property while the agent was not present.

6. The the method of claim 1, further comprising:
providing a CRM system with information comprising at least one of at least a portion of the property profile, at least a portion of the prospect profiles of prospects who have visited the property,
wherein the CRM system is a database associated with the agent.

7. The the method of claim 1, further comprising:
processing a request from the prospect client;
communicating at least a portion of the request to a property service provider server; and
reporting a response to the request to the prospect client,
wherein the request comprises at least one of a rental application, a loan approval application, a home inspection request, a home appraisal request, and a utility installation request, and
wherein the response comprises at least one of an appointment confirmation, a home inspection report, a home appraisal report, and a loan approval.

8. The method of claim 1, wherein the prospect can opt out of sharing at least a portion of the prospect profile with the agent.

9. The method of claim 1, wherein the third party server is a social network.

10. A method of a realty interaction server, comprising:
creating a property profile of a property in a database, using a processor and a memory,
wherein the property profile comprises a list of high interest prospects, a list of visitors, and at least one of a property identifier, an address, and a photo;
associating the property profile with an agent;
creating a prospect profile of a prospect in the database;
automatically populating the prospect profile by querying a third party server through a network using at least one of the prospect's phone number and the prospect's email address;
associating a beacon UUID of a beacon with the property profile;
processing a beacon UUID detected by a prospect client and a current beacon location,
wherein the current beacon location is a set of geo-spatial coordinates captured through the prospect client when the beacon UUID is detected;
validating the current beacon location by comparing the current beacon location with the property profile;
notifying the agent associated with the property profile when the current beacon location is inconsistent with the property profile;
updating the prospect profile and the property profile with a property visit when the current beacon location is consistent with the property profile; and
communicating at least a portion of the property profile to the prospect client,
wherein the prospect is at least one of a potential buyer and a potential renter, and
wherein the prospect client is a realty interaction client associated with the prospect.

11. The method of claim 10, further comprising:
determining that the agent is holding an open house at the property and that an agent client is broadcasting an agent UUID;
processing the agent UUID detected by the prospect client;
notifying the agent client and the prospect client that the prospect has successfully checked in to the open house;
communicating at least a portion of the prospect profile to the agent client;
communicating at least a portion of the property profile to the prospect client;
updating the list of high interest prospects associated with the property profile using a predictive engine;
communicating the list of high interest prospects to the agent client; and
recording when the prospect has left the open house in the database, and
wherein the agent client is a realty interaction client associated with the agent.

12. The method of claim 11, wherein the processing of the agent UUID detected by the prospect client is performed in response to the agent UUID being communicated to the realty interaction server automatically by the prospect client.

13. The method of claim 11, wherein the prospect profile comprises at least two of a name, an employer, the phone number, the email address, an educational institution, a potential reference, a lending institution, a loan pre-approval, an age, a photo, a list of properties visited, a list of property profiles viewed, and a list of open houses attended.

14. The method of claim 11, wherein the predictive engine populates the list of high interest prospects by quantifying an interest level of a prospect based upon at least one of: a number of times the prospect has visited the property, an amount of time spent at the property in an open house, a number of other properties visited, a location of other properties visited, a number of property profiles viewed, a ratio of properties viewed through the prospect client to the number of properties visited, and whether the property is being followed by the prospect.

15. The method of claim 14, wherein the predictive engine populates the list of high interest prospects based further upon a number of times the prospect has visited the property while the agent was not present.

16. The the method of claim 11, further comprising:
providing a CRM system with information comprising at least one of at least a portion of the property profile, at least a portion of the prospect profiles of prospects who have visited the property,
wherein the CRM system is a database associated with the agent.

17. The the method of claim 11, further comprising:
processing a request from the prospect client;
communicating at least a portion of the request to a property service provider server; and
reporting a response to the request to the prospect client,
wherein the request comprises at least one of a rental application, a loan approval application, a home inspection request, a home appraisal request, and a utility installation request, and
wherein the response comprises at least one of an appointment confirmation, a home inspection report, a home appraisal report, and a loan approval.

18. The method of claim 11, wherein the prospect can opt out of sharing at least a portion of the prospect profile with the agent.

19. The method of claim 11, wherein the third party server is a social network.

20. A system, comprising:
a network;
a prospect client;
a beacon;
an agent client;
a realty interaction server, comprising a database and a predictive engine:
to create a property profile of a property in the database, using a processor and a memory,
wherein the property profile comprises a list of high interest prospects, a list of visitors, and at least one of a property identifier, an address, and a photo;
to associate the property profile with an agent;
to create a prospect profile of a prospect in the database;
to automatically populate the prospect profile by querying a third party server through the network using at least one of the prospect's phone number and the prospect's email address;
to determine that the agent is holding an open house at the property and that the agent client is broadcasting an agent UUID;
to process the agent UUID detected by the prospect client;
to notify the agent client and the prospect client that the prospect has successfully checked in to the open house;
to communicate at least a portion of the prospect profile to the agent client;
to communicate at least a portion of the property profile to the prospect client;
to update the list of high interest prospects associated with the property profile using the predictive engine;
to communicate the list of high interest prospects to the agent client;
to record when the prospect has left the open house in the database;
to associate a beacon UUID of the beacon with the property profile;
to process a beacon UUID detected by the prospect client and a current beacon location,
wherein the current beacon location is a set of geo-spatial coordinates captured through the prospect client when the beacon UUID is detected;
to validate the current beacon location by comparing the current beacon location with the property profile;
to notify the agent associated with the property profile when the current beacon location is inconsistent with the property profile;
to update the prospect profile and the property profile with a property visit when the current beacon location is consistent with the property profile; and
to communicate at least a portion of the property profile to the prospect client,
wherein the prospect is at least one of a potential buyer and a potential renter,
wherein the prospect client is a realty interaction client associated with the prospect,
wherein the agent client is a realty interaction client associated with the agent, and
wherein the predictive engine populates the list of high interest prospects based further upon a number of times the prospect has visited the property while the agent was not present.
